(19) United States
(12) Patent Application Publication
(10) Pub. No.: US 2022/0373062 A1
(43) Pub. Date: Nov. 24, 2022

(54) ENVELOPING WORM GEAR GEARBOX FOR MECHANIZED IRRIGATION MACHINES

(71) Applicant: VALMONT INDUSTRIES, INC., Omaha, NE (US)

(72) Inventor: John Kastl, Wahoo, NE (US)

(73) Assignee: VALMONT INDUSTRIES, INC., Omaha, NE (US)

(21) Appl. No.: 17/732,597

(22) Filed: Apr. 29, 2022

Related U.S. Application Data
(60) Provisional application No. 63/190,322, filed on May 19, 2021.

(51) Int. Cl. F16H 1/16; A01G 25/09; F16H 57/039

(52) U.S. Cl. CPC F16H 1/16; A01G 25/092; F16H 57/039; F16H 2057/0213

(57) ABSTRACT

The present invention teaches an irrigation motor and gearset which include an enveloping worm drive gearbox for use with a mechanized irrigation machine. According to a preferred embodiment, the system of the present invention may include a gearbox which includes a worm drive and a reduction assembly. According to a preferred embodiment, the worm drive preferably includes a worm shaft, a worm, a first gear wheel, and a first wheel shaft. Preferably, the worm shaft and the first wheel shaft are oriented orthogonally to each other. According to a further preferred embodiment, the worm drive of the present invention is preferably a double enveloping worm drive with the worm and the first gear wheel each being throated, mated and fully enveloped gears.

### RELATED APPLICATIONS

The present application claims priority to U.S. Provisional Application No. 63/190,322 filed May 19, 2021.

### BACKGROUND AND FIELD OF THE PRESENT INVENTION:

### Field of the Present invention

The present invention relates generally to irrigation machines and, more particularly, to an enveloping worm gear gearbox for mechanized irrigation machines.

### Background of the Invention

Modern field irrigation machines are combinations of drive systems and sprinkler systems. Generally, these systems are divided into two types depending on the type of travel they are designed to execute: center pivot and/or linear.

Regardless of being center pivot or linear, common irrigation machines most often include an overhead sprinkler irrigation system consisting of several segments of pipe (usually galvanized steel or aluminum) joined together and supported by trusses, mounted on wheeled towers with sprinklers positioned along its length. These machines move in a circular pattern (if center pivot) or linear and are fed with water from an outside source (i.e. a well or water line). The essential function of an irrigation machine is to apply an applicant (i.e. water or other solution) to a given location.

In operation, mechanized irrigation equipment uses drive units (towers) to move the irrigation pipe through a given field (cultivation area). Conventionally, each drive unit utilizes two tires operating in parallel to propel the equipment through the field. These tires are driven by either a single drive motor or by individual drive motors through high-reduction gearboxes interposed between the drive unit structure and the tires (drive wheels).

In the past, mechanized irrigation systems have utilized two types of gearboxes for the final reduction from the driveshaft to the tire, worm wheel gearboxes and planetary gearboxes. Both designs have limitations when used for mechanized irrigation.

Planetary gearboxes generally require a minimum of 5 gears plus a gear carrier, all of which are precision machined. These high cost components then take additional time to be assembled into the final product, further adding to the cost. While planetary designs have a very high reduction ratio, high efficiency and excellent load carrying capacity, the direction of motion is essentially axial (e.g. the drive motor axis of rotation must be parallel to the tire axis of rotation). Consequently, individual motors must be mounted to the rear of each gearbox or a second 90 degree gearset must be added to allow the use of a single motor located centrally between the two tires (center-drive). This requirement adds additional cost and complexity to the drivetrain. For example, electronic interlocks are required if two motors are used in order to shut the system down if one motor were to fail.

Worm gear gearboxes provide the same high reduction ratio as a planetary design, but with only two gears (a worm and a worm-wheel). These are significantly cheaper to manufacture and assemble. Further the design is such that the direction of motion is perpendicular (e.g. the drive motor axis of rotation is at a 90 degree angle to the tire axis of rotation). This provides further advantages in that a single, center-drive motor may be used to drive both tires, further reducing cost. However, worm gearboxes are inefficient resulting in wasted energy, high wear rates, reduced load capacity, high temperatures and noise. Many of these challenges can be overcome by using a larger diameter worm-wheel to reduce the contact pressure between the worm and worm wheel. However, this configuration also adds costs due to the larger components and makes installation and service more difficult due to their increased size and weight.

Accordingly, what is currently needed is a gear design which can improve the wear life of irrigation drivetrains and increase the reliability of the irrigation system without increasing the size, or weight of the gearbox.

### SUMMARY OF THE DISCLOSURE

To minimize the limitations found in the prior art, the present invention provides a high load capacity, high reduction ratio gearbox with a 90 degree direction of motion in a compact, low cost package.

According to a preferred embodiment, the system of the present invention includes a drive motor configured to convert electrical power into torque which is transferred to a drive shaft. The drive shaft then preferably transfers the received torque to a gearbox which includes a worm drive and a reduction assembly.

According to a preferred embodiment, the worm drive preferably includes a worm shaft, a worm, a first gear wheel, and a first wheel shaft. Preferably, the worm shaft and the first wheel shaft are oriented orthogonally to each other. According to a further preferred embodiment, the worm drive of the present invention is preferably a double enveloping worm drive with the worm and the first gear wheel each being throated, mated and fully enveloped gears.

According to further preferred embodiments, the present invention preferably may include additional contact patches (and increased contact area) which preferably may allow the gearbox to carry higher loads for a longer period of time (higher capacity) without increasing the size of the worm or exceeding the capacity of modern lubricants and worm and other gear materials.

### BRIEF DESCRIPTION OF THE DRAWINGS

FIG. 1 shows an illustration of an exemplary irrigation machine in accordance with a first preferred embodiment of the present invention.

FIG. 2 shows a perspective view of an exemplary drive tower in accordance with a first preferred embodiment of the present invention.

FIG. 3 shows an illustration of an exemplary irrigation gearbox in accordance with a first preferred embodiment of the present invention.

FIG. 4 shows a cut-away view of the exemplary irrigation gearbox shown in FIG. 3 illustrating an exemplary worm gear in accordance with the present invention.

FIG. 5 shows an elevation view of the irrigation gearbox shown in FIG. 4.

### DESCRIPTION OF THE PREFERRED EMBODIMENTS

Reference is now made in detail to the exemplary embodiments of the invention, examples of which are illustrated in the accompanying drawings. Wherever possible, the same reference numbers will be used throughout the drawings to refer to the same or like parts. The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. As used throughout this application, the word “may” is used in a permissive sense (i.e., meaning “having the potential to”), rather than the mandatory sense (i.e. meaning “must”).

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

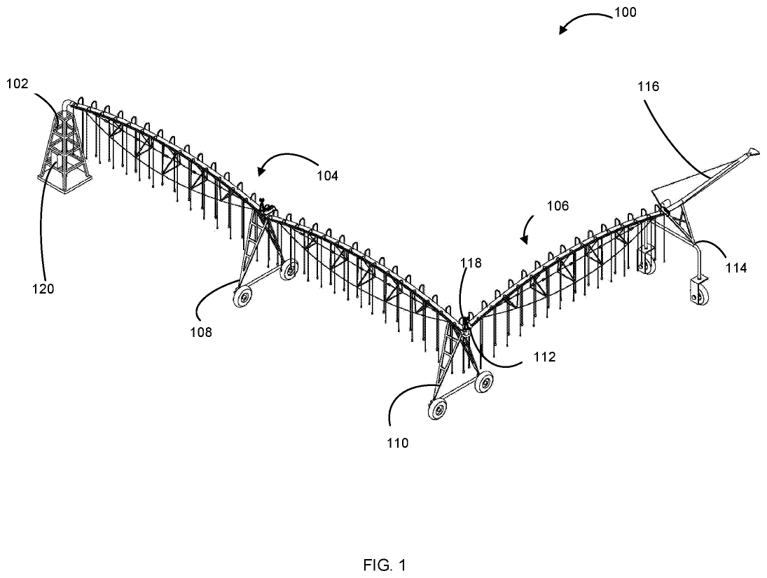

With reference now to FIG. 1, an exemplary irrigation machine 100 incorporating aspects of the present invention shall now be discussed. As should be understood, the irrigation system 100 disclosed in FIG. 1 is an exemplary irrigation system onto which the features of the present invention may be integrated. Accordingly, FIG. 1 is intended to be illustrative and any of a variety of alternative systems (i.e. fixed systems as well as linear and center pivot self-propelled irrigation systems; stationary systems; corner systems and/or bender type systems) may be used with the present invention without limitation. For example, although FIG. 1 is shown as a center pivot irrigation system, the exemplary irrigation system 100 of the present invention may also be implemented as a linear irrigation system. The example irrigation system 100 is not intended to limit or define the scope of the present invention in any way. According to further preferred embodiments, the present invention may be used with a variety of motor types such as gas powered, DC powered, switch reluctance, single phase AC and the like.

FIG. 1 illustrates an exemplary self-propelled irrigation system 100 which may be used with example implementations of the present invention. As should be understood, the irrigation system 100 disclosed in FIG. 1 is an exemplary irrigation system onto which the features of the present invention may be integrated. Accordingly, FIG. 1 is intended to be illustrative and any of a variety of systems (i.e. fixed systems as well as linear and center pivot self-propelled irrigation systems; corner systems) may be used with the present invention without limitation.

With reference now to FIG. 1, an exemplary irrigation machine 100 of the present invention preferably may include a center pivot structure 102, a main span 104, and supporting drive towers 108, 110. The exemplary irrigation machine 100 may also include a corner span 106 attached at a connection point 112. The corner span 106 may be supported and moved by a steerable drive unit 114. The corner span 106 may include a boom 116 and an end gun (not shown) and/or other sprayers. Additionally, a position sensor 118 may provide positional and angular orientation data for the system. A central control panel 120 may also be provided and may enclose on-board computer systems for monitoring and controlling the operations of the irrigation machine. The control panel 120 may also be linked to a transceiver for transmitting and receiving data between system elements, device/internet clouds, remote servers and the like.

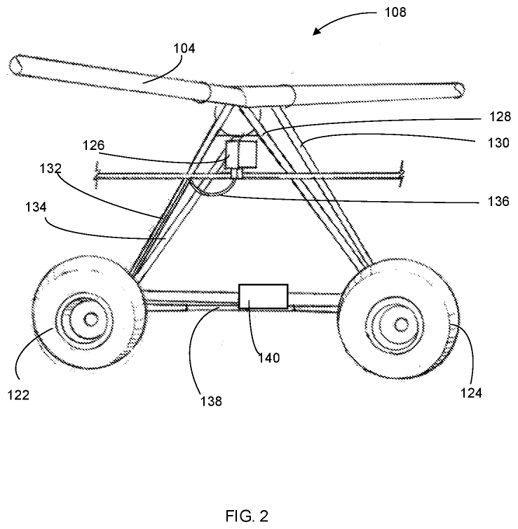

. With reference now to FIG. 2, an exemplary drive tower 108 supporting a span 104 is shown in more detail. As shown, the frame of the drive tower 108 includes supporting legs 128, 130, 132, 134 which transfer the weight of the supported span 104 onto one or more wheels 122, 124. According to a preferred embodiment, one or more of the supporting wheels 122, 124 are preferably drive wheels which are driven by one or more drive motors 140.

According to preferred embodiments, the one or more drive motors 140 used by the present invention may for example be variable speed motors or the like. For example, an exemplary motor used with the present invention may include: a switched reluctance motor (SRM), an AC induction motor with a variable frequency drive, a DC motor (such as a permanent magnet DC motor) or other motor types without limitation.

Referring again to FIG. 2, the drive tower 108 preferably includes a drive motor controller 126 which may receive control instructions from the tower control panel 120 or from another source. The drive motor controller 126 may preferably provide electrical power to the drive motor 140 via one or more electrical control lines/wires 136. In operation, the electrical power provided through the drive motor controller 126 may be transformed by the drive motor 140 into torque/rotational motion applied to a drive shaft 138.

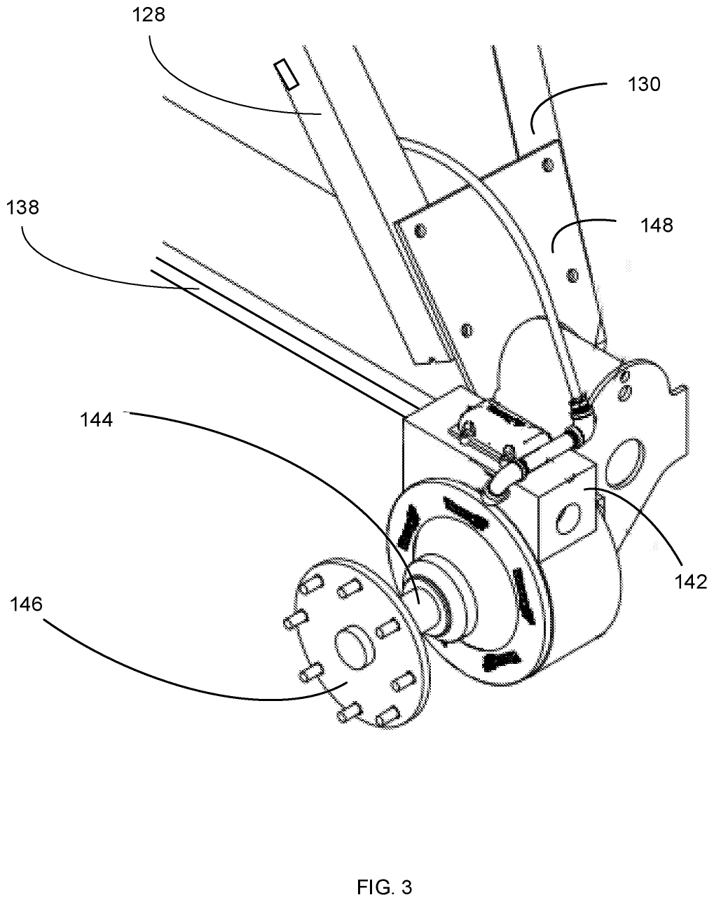

With reference now to FIG. 3, the torque from the drive shaft 138 is preferably then transferred to a worm gearbox 142 and any associated reduction assembly. Preferably, the worm gearbox 142 (and any reduction assembly) for use with the present invention may be calibrated to provide any desired gear ratio. For example, the present invention may include a 20:1, 40:1, or 52:1 gearbox or other gear arrangements with other reduction ratios without limitation.

Referring again to FIG. 3, the worm gearbox 142 as shown is preferably connected to a connecting plate 148 and secured to one or more supporting legs 128, 130. According to a preferred embodiment, the worm gearbox 142 preferably translates the received torque 90 degrees and transfers the torque onto a gearbox output shaft 144. As shown, the torque from the output shaft 144 is applied to a connected wheel hub 146 which secures a drive wheel 124 (shown in FIG. 2).

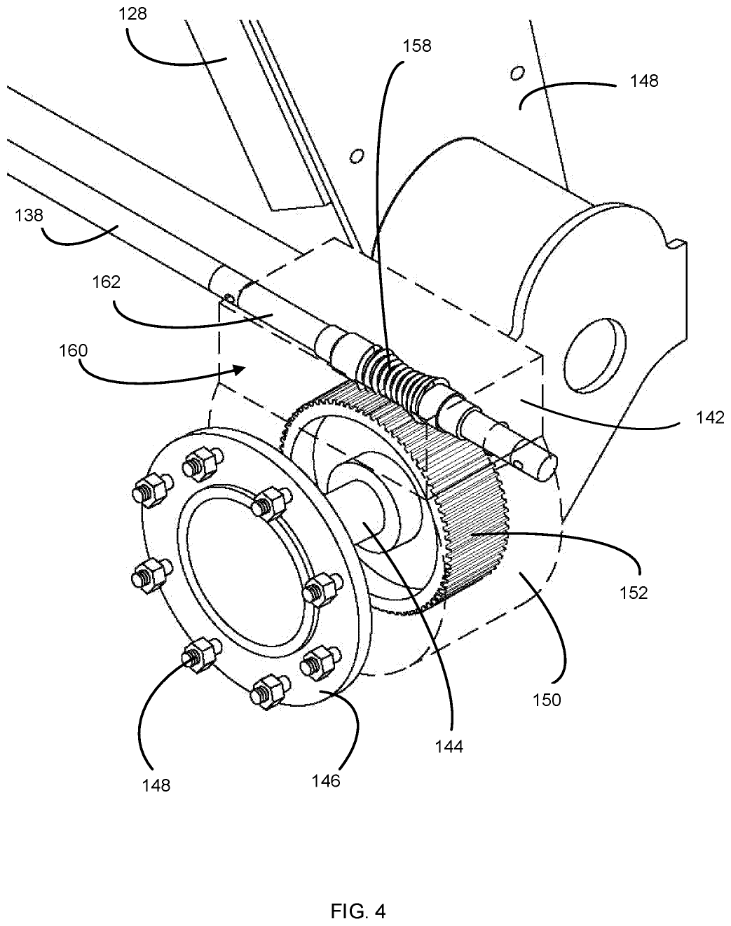

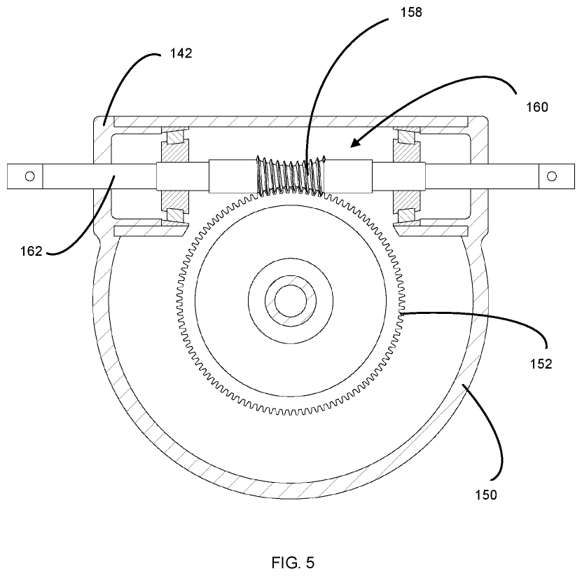

With reference now to FIGS. 4 and 5, the worm gearbox 142 is preferably adjacent to a wheel gearbox housing 150. The worm gearbox 142 preferably encloses a worm drive 160. According to preferred embodiments, the worm drive 160 preferably includes a worm/worm gear 158 connected to (or integrally formed with) a worm shaft 162. The worm shaft 162 is preferably linearly connected (directly or indirectly) to the drive shaft 138. According to a preferred embodiment, the teeth of the worm 158 may preferably be intermeshed with the gear teeth of a gear wheel 152 (or other reduction assembly component). The gear wheel 152 is preferably attached to a shaft 144 which is linked to a wheel hub 146. The wheel hub 146 preferably then transfers the torque to a drive wheel (not shown) which is connected to the wheel hub 146 using lug bolts 148 or the like.

According to preferred embodiments, the worm drive 160 of the present invention may preferably be a double enveloping worm drive or the like. Further, the worm 158 and any connected gear may preferably be mated, with each gear being fully throated and fully enveloping to support the highest loading. The present invention may further be used within a variety of other gearbox arrangements without limitation. According to alternative embodiments, any arrangement of reducing gears may alternatively be used without limitation. For example, the teeth of the worm/worm gear 158 may alternatively be intermeshed with the gear teeth of an intermediate gear/wheel or the like and/or another reduction assembly component to transfer torque to a given drive wheel.

According to further alternative embodiments, the worm 158 and/or other gears of the present invention may be linked to the main gear wheel 152 (or other intermediary gear) via a harmonic drive/gear set, a wobbling gear set, a nutating gear set or other type of gear or reduction gear mechanism. Further, one or more of these various gear sets may be used at various other points in the drive train of the present invention without limitation.

According to further alternative embodiments, the drive train of the present invention may preferably use a harmonic, wobbling and/or nutating gear set as the primary/main reduction mechanism of the present invention in place of the worm gear. Preferably, any provided harmonic, wobbling or nutating gear would be the main reduction mechanism and the need to provide a 90 degree change in direction in the drive train would be eliminated by incorporating an additional motor connected to the harmonic or nutating input gear (such that the motor's output shaft is at least parallel to the axis of the output shaft). According to this further alternative embodiment, the two motors provided on each drive unit would preferably be linked via an electrical control system to manage the motors such that they both rotate at the same rate, including an interlock so that if one motor failed the other motor could not start up.

According to a second alternative preferred embodiment, the system of the present invention may alternatively include only a single, center-drive motor and use the harmonic, wobbling or nutating gear as the main reduction mechanism. According to this second alternative preferred embodiment, any needed 90 degree change in direction may preferably be accomplished using any of a variety and/or combinations of gear types such as worm, bevel, spiral bevel or miter. Preferably, within this second alternative preferred embodiment, these alternative gearsets would provide only small reductions in the gear ratios, while the main gear reduction would be accomplished by the harmonic, wobbling and/or nutating gear set(s). Further, the harmonic, wobbling and/or nutating gearset's output shaft would preferably be directly connected to the output shaft of the gearbox.

According to further aspects of the second alternative embodiment, one or more of the harmonic, wobbling and/or nutating gear sets may preferably be utilized within the center-drive gear motor itself to provide reduction from the motor speed to the output speed of the center-drive. Within this design, a 90-degree change in direction may not be required as the motor may preferably be mounted horizontally such that each gear shaft is parallel with the output shaft of the center-drive gearmotor.

The scope of the present invention should be determined not by the embodiments illustrated above, but by the appended claims and their legal equivalents.

What is claimed is:

1. In an irrigation system including at least one span and a drive tower including a first drive wheel, a torque transfer system comprising:
a drive motor;
a drive motor controller, wherein the drive motor controller is configured to provide electrical power to the drive motor via one or more electrical control lines; wherein the drive motor is configured to convert the electrical power into torque;
a drive shaft, wherein the drive shaft is configured to receive torque from the drive motor; and
a worm gearbox, wherein the worm gearbox comprises a worm drive and a reduction assembly;
wherein the worm drive comprises a worm shaft and a worm;
wherein the drive shaft is configured to receive torque from the drive motor and to transfer the torque to the worm shaft and to the worm;
wherein the worm is configured to transfer torque to a first wheel gear; wherein the first wheel gear is attached to a first wheel shaft; wherein the first wheel shaft is connected to a wheel hub.

2. The system of claim 1, wherein the worm drive comprises a double enveloping worm drive.

3. The system of claim 2, wherein the worm and the first wheel gear are throated.

4. The system of claim 3, wherein the worm and the first wheel gear are mated, fully enveloped gears.

5. The system of claim 4, wherein the worm shaft and the first wheel shaft are oriented orthogonally to each other.

6. The system of claim 5, wherein the worm is comprised of gear teeth; wherein the gear teeth are integrally formed with the worm shaft.

7. The system of claim 6, wherein the worm shaft is linearly connected to the drive shaft.

8. The system of claim 7, wherein the worm is linked to the first wheel gear via a harmonic drive/gear set.

9. The system of claim 7, wherein the worm is linked to the first wheel gear via a wobbling gear set.

10. The system of claim 7, wherein the worm is linked to the first wheel gear via a nutating gear set.

11. In an irrigation system including at least one span and a drive tower including a first drive wheel, a torque transfer system comprising:
a first drive motor;
a second drive motor;
a first drive motor controller, wherein the first drive motor controller is configured to provide electrical power to the first drive motor via one or more electrical control lines;
wherein the first drive motor is configured to convert the electrical power into torque;
a second drive motor controller, wherein the second drive motor controller is configured to provide electrical power to the second drive motor via one or more electrical control lines; wherein the second drive motor is configured to convert the electrical power into torque;
an electrical control system; wherein the electrical control system is linked to the first and second motor controllers to match their rates of rotation;
a center drive shaft, wherein the center drive shaft is configured to receive torque from the first and second drive motors;
a first gearbox; wherein the first gear box comprises gears selected from the group of gears comprising: harmonic gears, wobbling gears and nutating gears;
wherein the drive shaft is configured to receive torque from the drive motor and to transfer the torque to the first gearbox;
wherein the first gearbox is configured to transfer torque to a first wheel gear; wherein the first wheel gear is attached to a first wheel shaft; wherein the first wheel shaft is connected to a wheel hub.

12. In an irrigation system including at least one span and a drive tower including a first drive wheel, a torque transfer system comprising:
a first drive motor;
a first drive motor controller, wherein the first drive motor controller is configured to provide electrical power to the first drive motor via one or more electrical control lines;
wherein the first drive motor is configured to convert the electrical power into torque;
a center drive shaft, wherein the center drive shaft is configured to receive torque from the first drive motors;
a first gearbox; wherein the first gear box comprises a gear selected from the group of gears comprising: harmonic gear, wobbling gear and nutating gear;
a second gear box; wherein the first gearbox is configured to transfer torque to the second gear box; and
a first wheel gear; wherein the first wheel gear is attached to a first wheel shaft; wherein the first wheel shaft is connected to a wheel hub;
wherein the second gear box is mechanically linked between the first gearbox and the first wheel gear; wherein the second gear box comprises a gear selected from the group of gears comprising: worm gear, bevel gear, spiral bevel gear and miter gear;
wherein the second gearbox is configured to transfer torque to the first wheel gear;
wherein the first wheel gear is attached to a first wheel shaft; wherein the first wheel shaft is connected to a wheel hub.
